(19) United States
(12) Patent Application Publication
(10) Pub. No.: US 2018/0048700 A1
(43) Pub. Date: Feb. 15, 2018

(54) DISTRIBUTION OF APPLICATION DATA BETWEEN MODEMS

(71) Applicant: QUALCOMM Incorporated, San Diego, CA (US)

(72) Inventors: Bapineedu Chowdary GUMMADI, Hyderabad (IN); Anurag TIWARI, Hardoi (IN); Hem AGNIHOTRI, Varanasi (IN); Venkata A Naidu BABBADI, Hyderabad (IN)

(21) Appl. No.: 15/234,803

(22) Filed: Aug. 11, 2016

(51) Int. Cl. H04L 29/08; H04L 5/00

(52) U.S. Cl. CPC H04L 67/10; H04L 5/0023; H04L 67/2814; H04W 88/02

(57) ABSTRACT

A user equipment (UE) may include a plurality of modems available to transmit data using different radio access technologies (RATs). For example, a UE may include a WiFi modem that allows the UE to connect to a wireless local area network (WLAN). The UE may further include a cellular modem that allows the UE to connect to a cellular network, such as a third generation (3G) network, fourth generation (4G) network, Long Term Evolution (LTE) network, LTE-Advanced (LTE-A) network, fifth generation (5G) network, and the like. The UE may select a RAT for transmission of data based on the data, an application associated with the data, or the like. The UE may then cause the data to be transmitted over the selected RAT, such as by providing the data to a transmission control protocol (TCP) stack associated with a modem for the selected RAT.

### BACKGROUND

### Field

The present disclosure relates generally to communication systems, and more particularly, to a device configured to distribute different application data between a plurality of modems.

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to support mobile broadband access through improved spectral efficiency, lowered costs, and improved services using OFDMA on the downlink, SC-FDMA on the uplink, and multiple-input multiple-output (MIMO) antenna technology. However, as the demand for mobile broadband access continues to increase, there exists a need for further improvements in LTE technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In aspects, a user equipment (UE) may include a plurality of modems available to transmit data using different networks. For example, a UE may include a WiFi modem that allows the UE to connect to a wireless local area network (WLAN) (e.g., using 2.4 gigahertz (GHz) and/or 5 GHz radio bands). The UE may further include a cellular modem that allows the UE to connect to a cellular network, such as a third generation (3G) network, fourth generation (4G) network, Long Term Evolution (LTE) network, LTE-Advanced (LTE-A) network, fifth generation (5G) network, and the like.

The plurality of modems at the UE may allow the UE to communicate data over more than one radio access technology (RAT). For example, due to increasing speeds of wireless standards (e.g., LTE) and/or throughput requirements, the UE may benefit from using the plurality of modems at the UE. For example, the UE may not prioritize WiFi over cellular data communication based on the availability of WiFi (e.g., if WiFi is available, the UE always selects WiFi). Rather, the UE may determine which RAT to use, for example, based on data that is to be communicated.

For example, a UE may prefer a secure data transfer for certain types of data transfers, such as personal data transfers, data transfers during corporate document sharing, data transfers during personal chats, data transfers in banking transactions, and the like. Therefore, the UE may select a cellular RAT instead of a WiFi RAT for such data communication because cellular communications may be more secure than WiFi communications.

According to another example, various web resources (e.g., web sites, streaming video, etc.) may be blocked—e.g., a corporation or university may block various web resources during certain time periods or permanently to reduce load on an internal WiFi network. In such a scenario, the UE may select a different RAT to access a web resource that may be unavailable using a first RAT.

In an aspect of the disclosure, a method, a computer-readable medium, and an apparatus are provided. The apparatus may be configured to determine data that is to be wireless communicated by the apparatus. The apparatus may be further configured to select, based on the data, a first RAT over which the data is to be communicated instead of a second RAT. The apparatus may be further configured to cause communication of the data over the first RAT using a first modem of the UE associated with the first RAT.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating LTE examples of a DL frame structure, DL channels within the DL frame structure, an UL frame structure, and UL channels within the UL frame structure, respectively.

FIG. 3 is a diagram illustrating an example of an evolved Node B (eNB) and user equipment (UE) in an access network.

FIG. 4 is a diagram of a wireless communications system.

FIG. 5 is a diagram of distribution of data between a plurality of modems.

FIG. 6 is a flowchart of a method of wireless communication.

FIG. 7 is a conceptual data flow diagram illustrating the data flow between different means/components in an exemplary apparatus.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

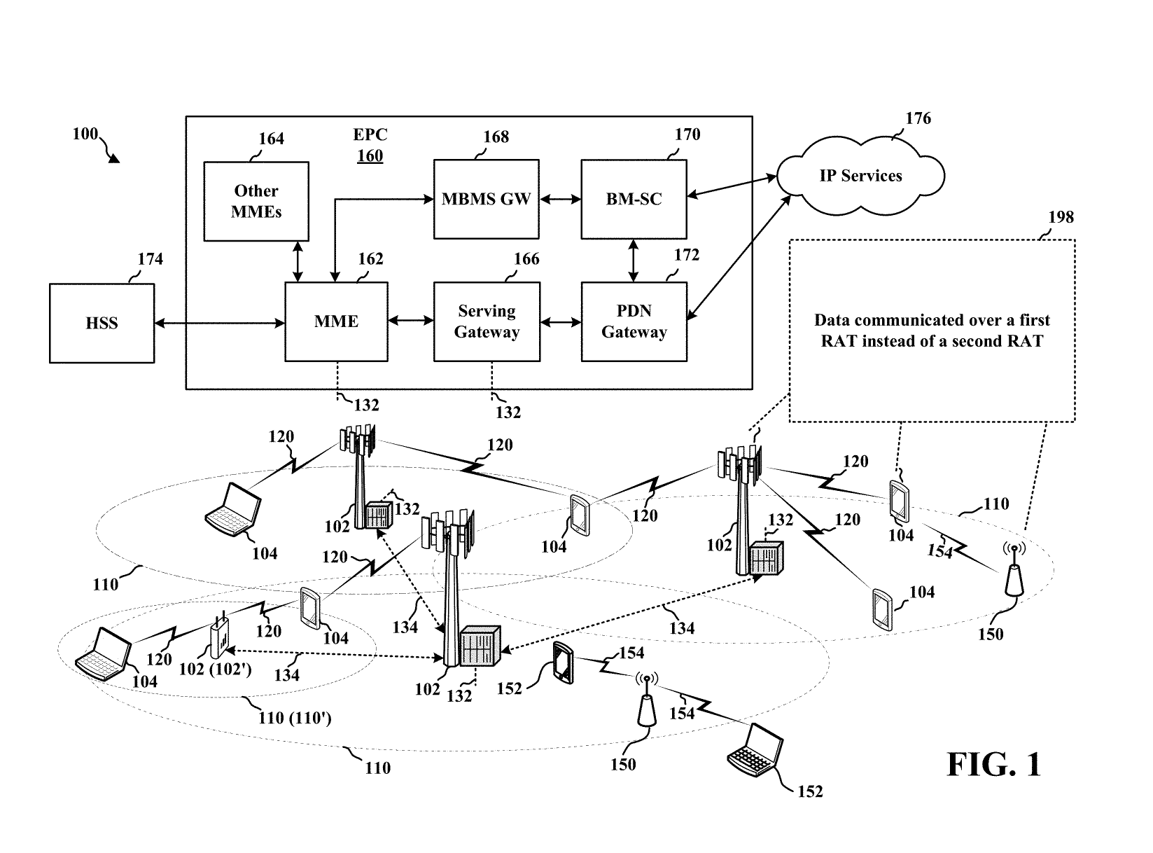

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include eNBs. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links may be through one or more carriers. The base stations 102/UEs 104 may use spectrum up to Y MHz (e.g., 5, 10, 15, 20 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ LTE and use the same 5 GHz unlicensed frequency spectrum as used by the Wi-Fi AP 150. The small cell 102′, employing LTE in an unlicensed frequency spectrum, may boost coverage to and/or increase capacity of the access network. LTE in an unlicensed spectrum may be referred to as LTE-unlicensed (LTE-U), licensed assisted access (LAA), or MuLTEfire.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to communicate data 198. In aspects, the UE 104 may include at least two modems and, accordingly, the UE 104 may be configured to communicate data 198 over a first RAT (e.g., E-UTRAN, including the base station 102) as well as over a second RAT (e.g., the WiFi RAT, including WiFi AP 150). In aspects, the UE 104 may determine a characteristic of the data 198 to be communicated and, based on the characteristic of the data, may select between the first RAT and the second RAT. Based on the selection, the UE 104 may cause communication of the data 198 over the selected RAT, e.g., causing transmission of data 198 to either a base station 102 or a WiFi AP 150, depending upon the selected RAT.

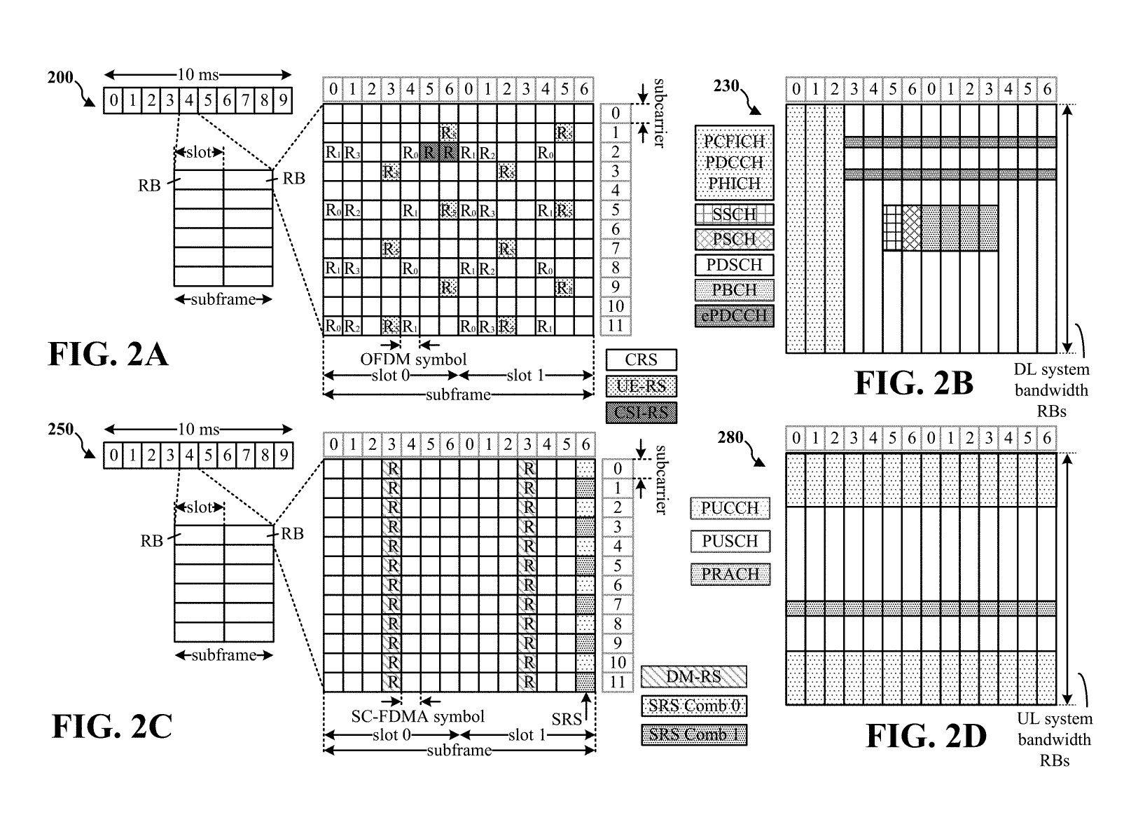

FIG. 2A is a diagram 200 illustrating an example of a DL frame structure in LTE. FIG. 2B is a diagram 230 illustrating an example of channels within the DL frame structure in LTE. FIG. 2C is a diagram 250 illustrating an example of an UL frame structure in LTE. FIG. 2D is a diagram 280 illustrating an example of channels within the UL frame structure in LTE. Other wireless communication technologies may have a different frame structure and/or different channels. In LTE, a frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). In LTE, for a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R₀, R₁, R₂, and R₃, respectively), UE-RS for antenna port 5 (indicated as R5), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (HACK) feedback based on the physical uplink shared channel (PUSCH). The primary synchronization channel (PSCH) is within symbol 6 of slot 0 within subframes 0 and 5 of a frame, and carries a primary synchronization signal (PSS) that is used by a UE to determine subframe timing and a physical layer identity. The secondary synchronization channel (SSCH) is within symbol 5 of slot 0 within subframes 0 and 5 of a frame, and carries a secondary synchronization signal (SSS) that is used by a UE to determine a physical layer cell identity group number. Based on the physical layer identity and the physical layer cell identity group number, the UE can determine a physical cell identifier (PCI). Based on the PCI, the UE can determine the locations of the aforementioned DL-RS. The physical broadcast channel (PBCH) is within symbols 0, 1, 2, 3 of slot 1 of subframe 0 of a frame, and carries a master information block (MIB). The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the eNB. The UE may additionally transmit sounding reference signals (SRS) in the last symbol of a subframe. The SRS may have a comb structure, and a UE may transmit SRS on one of the combs. The SRS may be used by an eNB for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

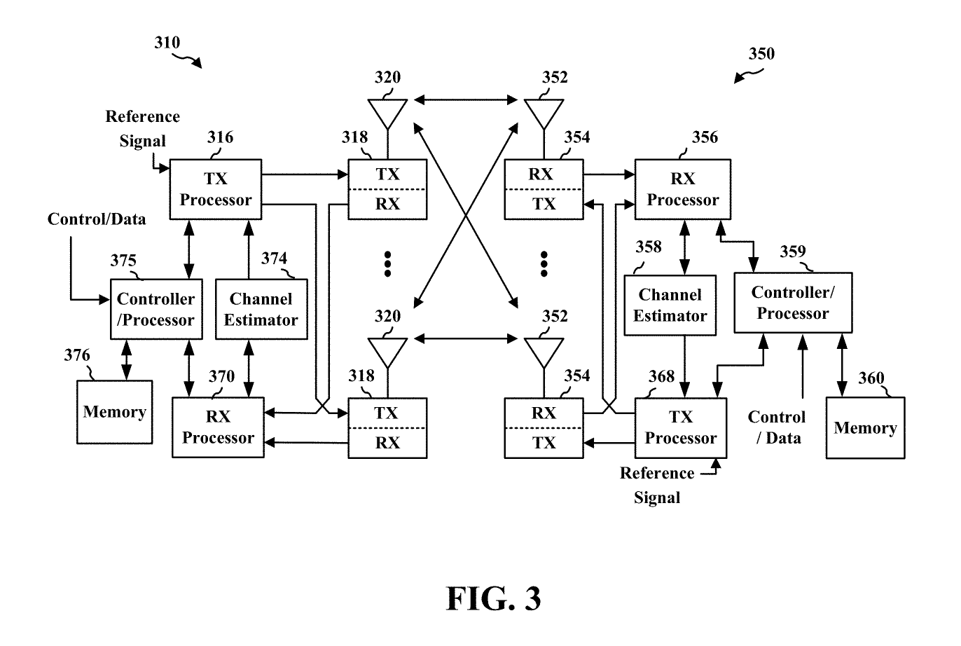

FIG. 3 is a block diagram of an eNB 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demuliplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 310. These soft decisions may be based on channel estimates computed by the channel estimator 358. The soft decisions are then decoded and deinterleaved to recover the data and control signals that were originally transmitted by the eNB 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the eNB 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demuliplexing of MAC SDUs from TBs, scheduling information reporting, error correction through HARQ, priority handling, and logical channel prioritization.

Channel estimates derived by a channel estimator 358 from a reference signal or feedback transmitted by the eNB 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the eNB 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

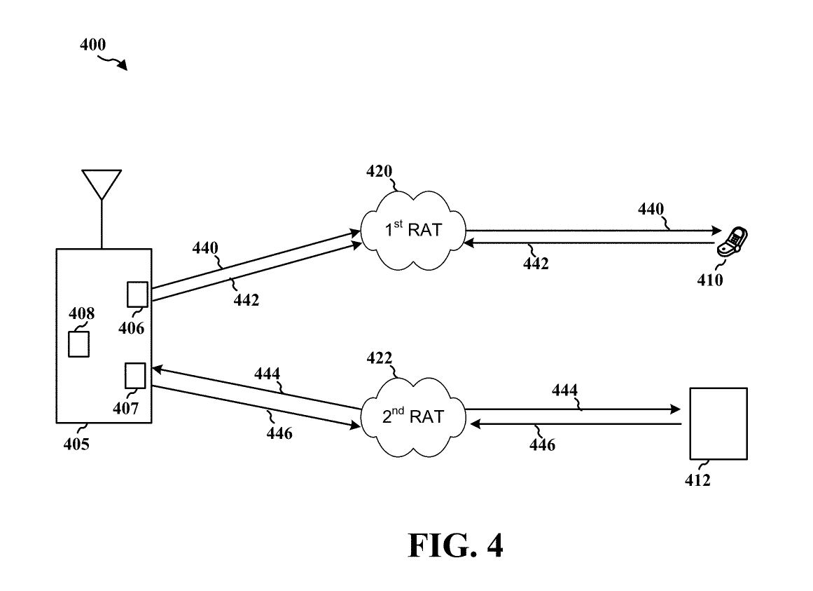

FIG. 4 is a diagram of a wireless communications system 400. The wireless communications system 400 includes at least one UE 405. The UE 405 may include at least two modems 406, 407. The at least two modems 406, 407 may facilitate use of different RATs for communication of data. The UE 405 may include at least one application 408 configured to generate data or request data, for example, to be communicated to or received from one or more communication devices 410, 412. Each of the communication devices 410, 412 may be any device or system with which the UE 405 may send data to or receive data from—e.g., the communication device 410 may be another UE, a web server, a streaming service, or the like.

In an aspect, the UE 405 may be configured to use different RATs 420, 422 for communicating data. Thus, the UE 405 may include a first modem 406 configured for communicating data over the first RAT 420 and may further include a second modem 407 configured for communicating data over the second RAT 422. In an aspect, the first RAT 420 may be a cellular RAT (e.g., an LTE RAT) and, therefore, the first modem 406 may be a cellular modem (e.g., an LTE modem). The second RAT 422 may be a WiFi RAT and, therefore, the second modem 407 may be a WiFi modem.

In an aspect, the UE 405 may determine a characteristic of the data to be wirelessly communicated by the UE 405, such as data provided or requested by the application 408. Based on the characteristic of the data, the UE 405 may determine whether the data is to be communicated over the first RAT 420 or the second RAT 422.

In an aspect, the UE 405 may determine a type of data that is to be communicated (e.g., the characteristic of the data may be a type of the data). The UE 405 may determine the type of data according to various approaches. For example, the first UE 405 may determine the type of data based on the application 408 from which the data originates. In another example, the UE 405 may determine the type of data based on a destination for that data (e.g., one of the communication devices 410, 412). In another aspect, the UE 405 may determine the type of data based on the data itself and/or metadata associated therewith (e.g., metadata may indicate that the data is sensitive and should be communicated securely). Based on the type of data that is to be communicated, the UE 405 may select either the first RAT 420 or the second RAT 422.

For example, the type of data may be sensitive data (e.g., data originating from a secure application, such as a banking application). The UE 405 may determine that certain types of data are to be securely communicated, such as personal data transfers, such as corporate document sharing, personal chats, banking transactions, one or more of which may originate at the application 408. Based on the type of data associated with the application 408, the UE 405 may select a cellular RAT (e.g., the first RAT 420) instead of a WiFi RAT (e.g., the second RAT 422) for such data communication because the WiFi RAT may be less secure than the cellular RAT. According to this example, the UE 405 may cause communication of data 440 over the first RAT 420 using the first modem 406. In some aspects, the UE 405 may receive a response 442 to the data 440. Corresponding to the transmission of the data 440 over the first RAT 420, the UE 405 may receive the response 442 over the first RAT 420 using the first modem 406 of the UE 405.

In another example, the type of data may be streaming data (e.g., a request for streaming video from the communication device 412). The UE 405 may determine that such streaming data should be communicated over the second RAT 422—e.g., the second RAT 422 may be a WiFi RAT which may offer greater speeds and/or be subject to less data constraints than the first RAT 420. Therefore, the UE 405 may select the second RAT 422 instead of the first RAT 420 for streaming services. According to another example, the UE 405 may determine that streaming should be communicated over the first RAT 420—e.g., the first RAT 420 may be an LTE RAT, which may offer greater speeds in different environments. According to this example, the UE 405 may cause communication of a request 444 over the second RAT 422 using the second modem 407. In response to the request 444, the UE 405 may receive streaming data over the second RAT 422 using the second modem 407 of the UE 405.

In an aspect, the UE 405 may be configured to dynamically select either the first RAT 420 and/or the second RAT 422 for communication data. In one aspect, the UE 405 may be configured to identify an issue associated with communication of data over one RAT and, cause communication over the other RAT based on the issue. In one aspect, the issue may be an absence of received data over a RAT. For example, the UE 405 may send a request 444 for streaming data over the second RAT 422 using the second modem 407. The UE 405 may detect that the time for a response to the request 444 has timed out and, therefore, the UE 405 may determine there is an issue with the communication over the second RAT. In another example, the UE 405 may send a request 444 for streaming data over the second RAT 422 using the second modem 407 and the response 446 may be unexpected, such as an message indicating access to the streaming service is blocked over the second RAT 422 or a redirect page that is an expected response to request 444. In another example, the UE 405 may be configured to transmit a ping (e.g., a ping to communication device 412) and, if no response to the ping is detected, the UE 405 may determine that there is an issue with communication using the second RAT 422.

In an aspect, the UE 405 may be configured to dynamically select the first RAT 420 or the second RAT 422 based on one or more other stored parameters. For example, the UE 405 may be configured to select either the first RAT 420 or the second RAT 422 based on a time of day (e.g., the first RAT 420 may be selected on evenings or on weekends).

In response, the UE 405 may be configured to request streaming services over the first RAT 420 based on the identified issue of receiving services through the second RAT 422. Thus, the UE 405 may send data 440 (including a request for streaming services) over the first RAT 420 using the first modem 406.

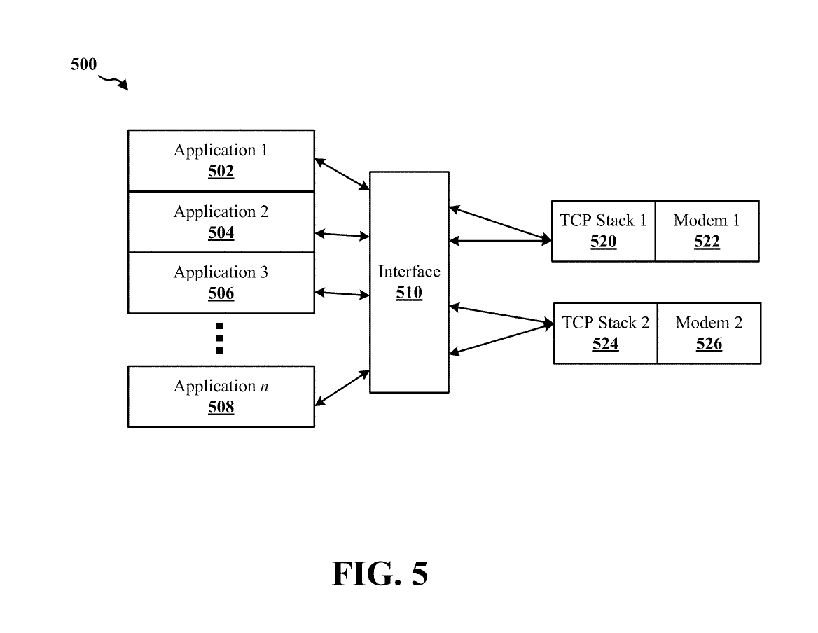

FIG. 5 is a block diagram distribution of data between a plurality of modems. The aspects described herein may be implemented in a UE 500, which may be an aspect of the UE 405. According to aspects, the UE includes at least two modems 522, 526. Each modem 522, 526 may be configured to communicate data over a respective RAT—e.g., the first modem 522 may be configured as a cellular modem 522 (e.g., an LTE, LTE-A, 5G modem), while the second modem 526 may be configured as a WiFi modem. In aspects, each modem may be associated with a respective Transmission Control Protocol (TCP) stack 520, 524. Each TCP stack 520, 524 may include a plurality of layers configured to encapsulate and/or extract data packaged according to a protocol, e.g., a TCP and Internet Protocol (IP).

The UE 500 may further include a plurality of applications 502, 504, 506, 508. According to aspects, the applications 502, 504, 506, 508 may reside at an application layer of the UE 500, which may be a higher layer than the TCP stacks 520, 524. Each application 502, 504, 506, 508 may be configured to send and/or receive some data over a network. For example, a first application 502 may be a web browser, a second application 504 may be configured as a personal messaging application, a third application 506 may be configured as a banking application, and a fourth application 508 may be configured as a streaming video application.

In aspects, the UE 500 may further include an interface 510. The interface 510 may be implemented as software, hardware, or a combination of hardware/software. In aspects, the interface 510 may be implemented at a layer of the UE 500. For example, the interface 510 may be implemented at an application layer of the UE 500. The interface 510 may be configured to provide data (e.g., data from the applications 502, 504, 506, 508) to either the first TCP stack 520 or the second TCP stack 524 for transmission over the first RAT using the first modem 522 or for transmission over the second RAT using the second modem 526, respectively. Similarly, the interface 510 may be configured to receive data from both the first TCP stack 520 (received over the first RAT using the first modem 522) and the second TCP stack 524 (received over the second RAT using the second modem 526) and provide the received data to a respective application 502, 504, 506, 508 to which the data is directed (e.g., according to a packet header or other identifier associated with a respective application 502, 504, 506, 508).

The interface 510 may be configured to determine which TCP stack 520, 524 is to receive data from or send data to an application 502, 504, 506, 508. For example, the interface 510 may include or may be configured to access a plurality of rules that specify a RAT over which data is to be communicated. According to one aspect, the interface 510 may be configured to determine which TCP stack 520, 524 is to be used statically. According to one aspect, the interface 510 may be configured to determine which TCP stack 520, 524 is to be used dynamically.

In an aspect, the interface 510 may determine the RAT over which data is to be communicated may be preconfigured, for example, according to the application 502, 504, 506, 508 associated with that data. In one aspect, this configuration may be based on user input. A user of the UE 500 may configure over which RAT different data from the applications 502, 504, 506, 508 is to be communicated.

For example, a user may be desire to keep data communication over a cellular RAT under a certain amount of data usage per month due to data constraints imposed by a provider or subscription plan limits. Additionally, a user may prefer WiFi when a WiFi connection provides faster speeds than a cellular connection. Accordingly, a rule may be configured at the interface 510 that indicates data should be sent over the WiFi RAT when WiFi is available. Further to such an example, the fourth application 508 may be a streaming video application. The fourth application may send a request for streaming video. The interface 510 may intercept this request and, based on one or more preconfigured rules, may determine that streaming video is to be communicated over the second RAT (e.g., the WiFi RAT). Accordingly, the interface 510 may provide this request to the second TCP stack 524 for transmission over the second RAT using the second modem 526. Similarly, streaming video data received over the second RAT using the second modem 526 may travel up the second TCP stack 524 to the interface 510. The interface 510 may then provide this streaming video data to the fourth application 508.

According to another example, a user may desire data communication associated with certain applications be secure. Accordingly, a rule may be configured at the interface 510 that indicates that data from an application 502, 504, 506, 508 should be secure. Further to such an example, the third application 508 may be a banking application. The third application 506 may send a banking-related data (e.g., transfer of funds, balance inquiry, etc.). The interface 510 may intercept this data and, based on one or more preconfigured rules, may determine that data from the third application 506 is to be communicated over the first RAT (e.g., the cellular RAT), which may offer greater security than the second RAT (e.g., the WiFi RAT). For example, a rule may indicate data having a specific characteristic (e.g., banking-related data) should be communicated over a specific RAT (e.g., the cellular RAT). Accordingly, the interface 510 may provide this data to the first TCP stack 520 for transmission over the first RAT using the first modem 522. Similarly, data for the third application 506 may be received over the first RAT using the first modem 522 and may travel up the first TCP stack 520 to the interface 510. The interface 510 may then provide this data to the third application 506.

In an aspect, the interface 510 may be configured to dynamically determine which TCP stack 520, 524 is to be used for communicating data associated with an application 502, 504, 506, 508. For example, the interface 510 may be configured to make this determination based on a type of request (e.g., a secure request, such as an https request). In another example, the interface 510 may be configured to make this determination based on an issue with a RAT—e.g., the interface 510 may be configured to send data down a different TCP stack if the interface 510 detects an issue (e.g., an error) associated with the RAT associated with the other TCP stack.

For example, the interface 510 may be configured to receive data from a second application 504, which may be configured as a personal messaging application. The interface 510 may determine that personal messaging data should be securely communicated. Therefore, even if the interface 510 determines that the second RAT (e.g., WiFi RAT) is available, the interface 510 may determine that personal messaging data would be more secure if communicated over the first RAT (e.g., the cellular RAT), for example, if the interface 510 detects that the second RAT is unsecured or uses an undesirable security algorithm (e.g., Wired Equivalent Privacy (WEP)). The second application 504 may send a personal message. The interface 510 may intercept this data and may determine that this data is to be communicated over the first RAT (e.g., the cellular RAT), which may offer greater security than the second RAT (e.g., the WiFi RAT). For example, the interface 510 may determine that data is to be communicated over the first RAT based on a characteristic of the data (e.g., a data type indicating a private message, metadata, etc.) or based on the second application 504 that provided the private message. Accordingly, the interface 510 may provide the private message to the first TCP stack 520 for transmission over the first RAT using the first modem 522. Similarly, data for the second application 504 may be received over the first RAT using the first modem 522 and may travel up the first TCP stack 520 to the interface 510. The interface 510 may then provide this data to the second application 504.

According to another example, interface may be configured to communicate data with a first application 502, which may be configured as a web browser. The interface 510 may determine that web browser data should be communicated over any available RAT and may determine that web browser data should initially be communicated over the second RAT (e.g., the WiFi RAT). Therefore, when interface 510 receives a request (e.g., an http request) from the first application 502, the interface 510 may send the request to the second TCP stack 524. However, the interface 510 may detect an issue with the communication of the request over the second RAT.

For example, the interface 510 may determine that a response to the request is unexpected, such as in the case of a redirect page or a page indicating that the request has been blocked. Therefore, the interface 510 may determine that the request should be communicated over the first RAT (e.g., the cellular RAT) based on the issue with data communication over the second RAT. Accordingly, the interface 510 may provide the request to the first TCP stack 520 for transmission over the first RAT using the first modem 522. The interface 510 may buffer a request in order to send the request again or the interface 510 may receive the request again from the first application 502.

In another example, the interface 510 may determine that an absence of response to the request, such as due to poor connectivity with the second RAT. In an aspect, the interface 510 may start a timer in association with transmission of the request and if no response is received before expiration of the timer, the interface 510 may determine the absence of a response to the request. Therefore, the interface 510 may determine that the request should be communicated over the first RAT (e.g., the cellular RAT) based on the issue with data communication over the second RAT (e.g., no response has been received within a predetermined period of time). Accordingly, the interface 510 may provide this request to the first TCP stack 520 for transmission over the first RAT using the first modem 522. The interface 510 may buffer a request in order to send the same request again or the interface 510 may receive the request again from the first application 502.

According to one aspect, the interface 510 may be configured to transmit a ping to determine the availability of a RAT. For example, the interface 510 may ping one or more servers using the second RAT (e.g., WiFi RAT) to determine if the second RAT is available. If no response to the ping is received, then then interface 510 may determine that the second RAT is unavailable. In response, the interface 510 may provide this data from the applications 502, 504, 506, 508 to the first TCP stack 520 for transmission over the first RAT using the first modem 522. The interface 510 may periodically transmit one or more pings over the second RAT to determine if the second RAT is available (e.g., when the UE 500 connects to a new WiFi network or after a predetermined period of time of detecting unavailability of the second RAT).

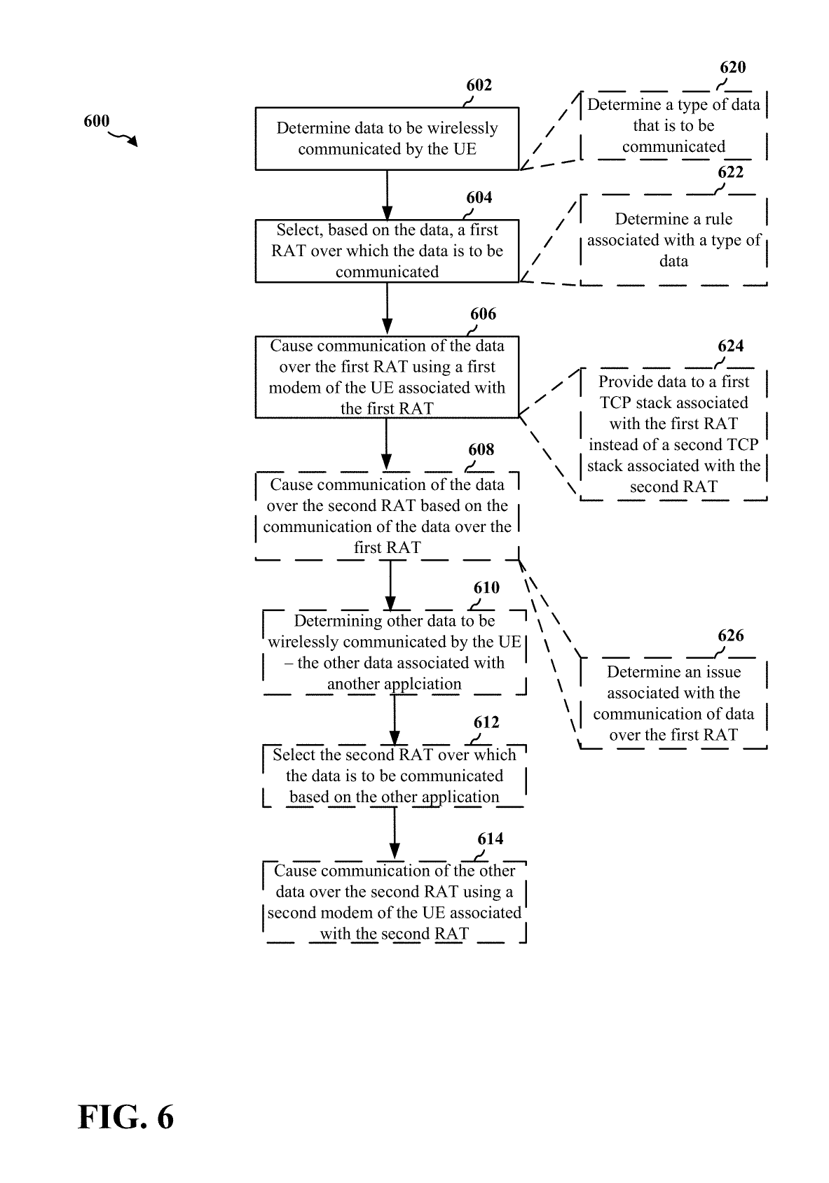

FIG. 6 is a flowchart 600 of a method of wireless communication. The method may be performed by a UE (e.g., the UE 405, the apparatus 702/702′). Although FIG. 6 illustrates a plurality of operations, one of ordinary skill will appreciate that one or more operations may be transposed and/or contemporaneously performed. Further, one or more operations of FIG. 6 may be optional (e.g., as denoted by dashed lines) and/or performed in connection with one or more other operations.

Beginning first with operation 602, the UE may be configured to determine data to be wirelessly communicated by the UE. In the context of FIG. 4, the UE 405 may determine data to be wirelessly communicated, which may be data provided by the application 408 (e.g., data 440, request 444, etc.). In the context of FIG. 5, the interface layer 510 may receive, from one of the applications 502, 504, 506, 508, data which the interface layer 510 determines is to be wirelessly communicated.

In one aspect, operation 602 includes operation 620. At operation 620, the UE may determine a type of data that is to be communicated. In various aspects, the UE may determine the type of data communicated based on, for example, the data itself (e.g., banking-related data, a private message, etc.), an application which provided the data (a banking application, a messaging application, etc.), or metadata associated with the data (e.g., a request to a secure server may indicate the communication of such data should be secure, such as an https request).

At operation 604, the UE may select, based on the data, a first RAT over which the data is to be communicated. For example, the first RAT may be a cellular RAT or a WiFi RAT. In the context of FIG. 4, the UE 405 may select, based on the data from the application 408, either the first RAT 420 or the second RAT 422 over which the data is to be communicated. In the context of FIG. 5, the interface 510 may determine that the data from one of the applications 502, 504, 506, 508 is to be communicated over either a first RAT associated with a first TCP stack 520 or communicated over a second RAT associated with a second TCP stack 524.

In an aspect, operation 606 may include operation 622. At operation 622, the UE may determine a rule associated with the type of data to be wirelessly communicated. For example, the UE may apply a rule that indicates that data of a secure type is to be communicated over a cellular RAT, or the UE may determine a rule that indicates data of a streaming video type is to be communicated over a WiFi RAT. Accordingly, the UE may access one or more rules and apply the one or more rules to the type of data to determine a RAT over which the data is to be wirelessly communicated.

In the context of FIG. 4, the UE 405 may determine a rule associated with the type of data from the application 408. In the context of FIG. 5, the interface 510 may determine a rule associated with the type of data from one of the applications 502, 504, 506, 508.

At operation 606, the UE may cause communication of the data over the selected RAT, e.g., the first RAT. In an aspect, the UE may cause communication of the data over the selected RAT by providing the data to a TCP stack associated with the selected RAT. In the context of FIG. 4, the UE 405 may cause communication of the data over the selected RAT (e.g., the first RAT 420) using a first modem 406 associated with the first RAT 420. In the context of FIG. 5, the interface 510 may cause communication of the data over the selected RAT (e.g., the first RAT) using a first modem 522 associated with the first RAT.

In aspects, operation 606 includes operation 624. At operation 624, the UE may cause communication of the data over the selected RAT (e.g., the first RAT) by providing the data to a first TCP stack associated with the first RAT instead of a second TCP stack associated with the second RAT. In the context of FIG. 4, the UE 405 may cause communication of the data over the selected RAT (e.g., the first RAT 420) using a first modem 406 associated with the first RAT 420 by providing the data to a first TCP stack associated with the first RAT 420 instead of a second TCP stack associated with the second RAT 422 (e.g., the first TCP stack may encapsulate/encode data for the first modem 406). In the context of FIG. 5, the interface 510 may cause communication of the data over the selected RAT (e.g., the first RAT) using a first modem 522 associated with the first RAT by providing the data to the first TCP stack 520 associated with the first RAT instead of the second TCP stack 524 associated with the second RAT.

At operation 608, the UE may cause communication of the data over another RAT (e.g. the second RAT) based on the communication of the data over the selected RAT (e.g., the first RAT). In the context of FIG. 4, the UE 405 may cause communication of the data over the other RAT (e.g., the second RAT 422) using a second modem 407 associated with the second RAT 422. In the context of FIG. 5, the interface 510 may cause communication of the data over the other RAT (e.g., the second RAT) using a second modem 526 associated with the second RAT.

In an aspect, operation 608 may include operation 626. At operation 626, the UE may determine an issue associated with the communication of data over the first RAT. For example, the UE may detect an unexpected response (e.g., a redirect page) or a predetermined time for reception of a response to the data may elapse. In response, the UE may cause communication of data over the other RAT (e.g., the second RAT) based on the issue associated with communication of data over the initially selected RAT (e.g., the first RAT). In another example, the UE may detect failure of a voice-over WiFi (VoWifi) call, such as when an attempt to establish a VoWifi connection fails (e.g., the UE detects a lack of a response to a connection request from the UE for the VoWifi call). In response, the UE may cause communication of data over the other RAT (e.g., the second RAT) based on the issue associated with communication of data over the initially selected RAT (e.g., the first RAT). Accordingly, the UE may establish the VoWifi connection over the other RAT.

At operation 610, the UE may he UE may be configured to determine other data to be wirelessly communicated by the UE—the other data associated with another application. In effect, the UE may be configured to select a RAT from a plurality of RATs based on application layer data, so that communication over the plurality of RATs may contemporaneously occur consistent with conditions associated with applications and data received therefrom. Thus, data from different applications may be distributed to different modems for transmission over different RATs.

In the context of FIG. 4, the UE 405 may determine other data to be wirelessly communicated, which may be data provided by another application other than the application 408. In the context of FIG. 5, the interface layer 510 may receive, from another one of the applications 502, 504, 506, 508, other data which the interface layer 510 determines is to be wirelessly communicated.

At operation 612, the UE may select, based on the other data, a second RAT over which the data is to be communicated. For example, the second RAT may be a cellular RAT or a WiFi RAT. In the context of FIG. 4, the UE 405 may select, based on the other data, either the first RAT 420 or the second RAT 422 over which the data is to be communicated. In the context of FIG. 5, the interface 510 may determine that the other data from one of the applications 502, 504, 506, 508 is to be communicated over either a first RAT associated with a first TCP stack 520 or communicated over a second RAT associated with a second TCP stack 524.

At operation 614, the UE may cause communication of the other data over the other selected RAT, e.g., the second RAT. In the context of FIG. 4, the UE 405 may cause communication of the other data over the other selected RAT (e.g., the second RAT 422) using a second modem 407 associated with the second RAT 422. In the context of FIG. 5, the interface 510 may cause communication of the data over the selected RAT (e.g., the second RAT) using a second modem 526 associated with the second RAT.

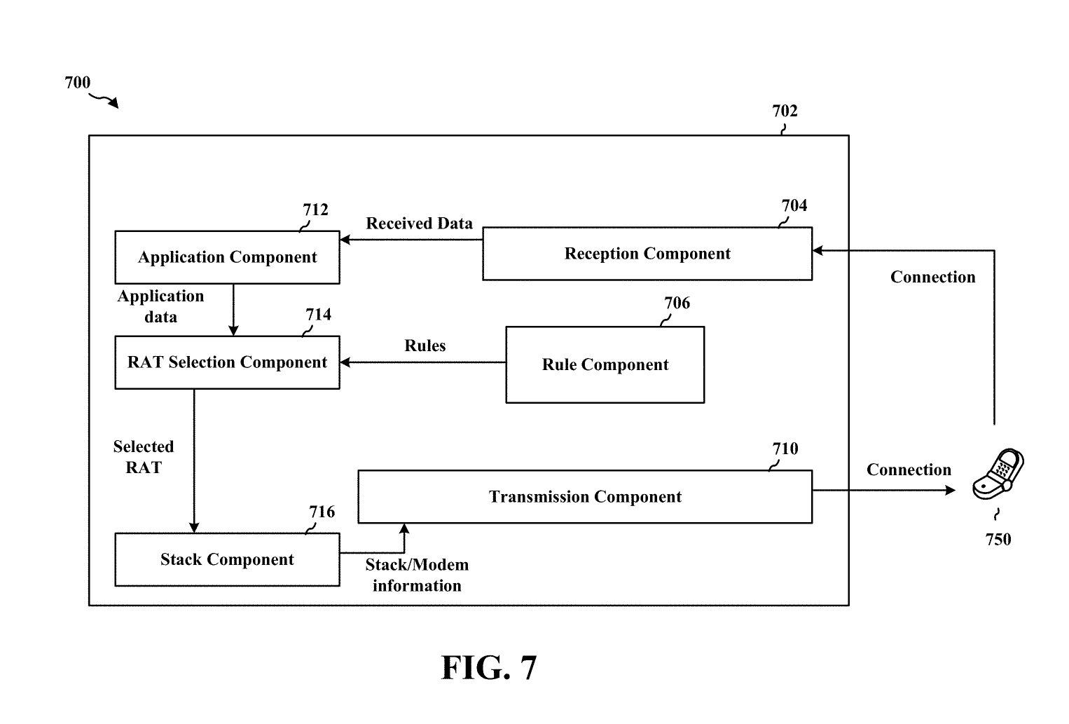

FIG. 7 is a conceptual data flow diagram 700 illustrating the data flow between different means/components in an exemplary apparatus 702. The apparatus may be a UE (e.g., the UE 405 or the UE 500).

The apparatus may include an application component 712. The application component 712 may be configured to determine data that is to be wirelessly communicated by the apparatus 702. The application component 712 may be integrated with or communicatively coupled with an application layer of the apparatus 702 and may be configured to receive data from one or more applications executed by the apparatus 702. The application component 712 may be configured to provide this application data to a RAT selection component 714.

The RAT selection component 714 may be configured to select between a plurality of RATs. Based on the application data, the RAT selection component may be configured to select a first RAT over which the application data is to be communicated instead of a second RAT.

In an aspect, the RAT selection component 714 may be configured to select a second RAT based on an issue with a first RAT. For example, the RAT selection component 714 may determine that no response is received to a transmission over the first RAT (e.g., a response to an application request for data, a response to a ping, etc.) or that an unexpected response is received (e.g., a redirect page to a request to access a web page). Accordingly, the RAT selection component 714 may be configured to select the second RAT for transmission of the application data, e.g., in order to attempt successful communication of the application data.

In an aspect, the RAT selection component 714 is communicatively coupled with a rule component 706. The rule component 706 may be configured to provide, to the RAT selection component, one or more rules associated with selecting a RAT. The rules may be based on, for example, a type of data (e.g., secure data or streaming video data) and may indicate a RAT that is to be selected based on the type of data received from the application component 712. The RAT selection component 714 may be configured to apply the one or more rules to the application data.

In an aspect, the RAT selection component 714 may be configured to provide an indication of the selected RAT to a stack component 716. The stack component 716 may be configured to cause communication of the data over the selected RAT using a modem of the apparatus 702 that is associated with the first RAT. In an aspect, the stack component 716 may be configured to provide the data to a TCP stack associated with the selected RAT instead of another TCP stack associated with an unselected RAT. The stack component 716 may cause the transmission component 710 to use a modem of the UE associated with the selected RAT for transmission of the application data, instead of using another modem of the UE associated with an unselected RAT.

The apparatus may include additional components that perform each of the blocks of the algorithm in the aforementioned flowchart of FIG. 6. As such, each block in the aforementioned flowchart of FIG. 6 may be performed by a component and the apparatus may include one or more of components 704, 706, 710, 712, 714, 716. The components may be one or more hardware components specifically configured to carry out the stated processes/algorithm, implemented by a processor configured to perform the stated processes/algorithm, stored within a computer-readable medium for implementation by a processor, or some combination thereof.

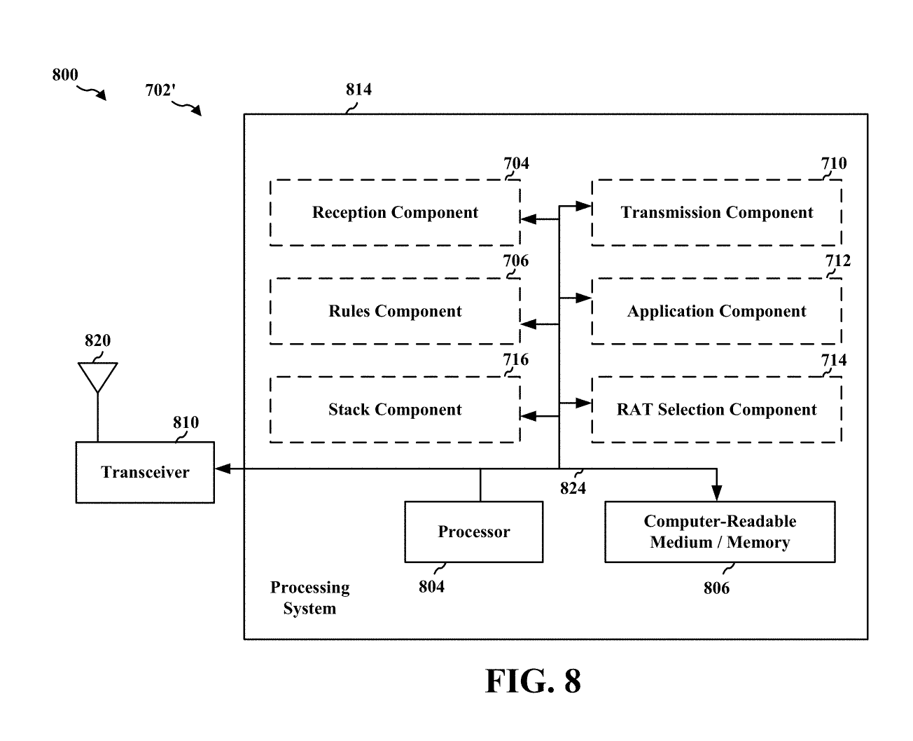

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 710, 712, 716, and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception component 704. In addition, the transceiver 810 receives information from the processing system 814, specifically the transmission component 710, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 710, 712, 716. The components may be software components running in the processor 804, resident/stored in the computer readable medium/memory 806, one or more hardware components coupled to the processor 804, or some combination thereof. The processing system 814 may be a component of the UE 350 and may include the memory 360 and/or at least one of the TX processor 368, the RX processor 356, and the controller/processor 359.

In one configuration, the apparatus 702/702′ for wireless communication includes means for determining data to be wirelessly communicated by the UE. The apparatus 702/702′ may further include means for selecting, based on the data, a first RAT over which the data is to be communicated instead of a second RAT. The apparatus 702/702′ may further include means for causing communication of the data over the first RAT using a first modem of the UE associated with the first RAT. In an aspect, the means for causing communication of the data over the first RAT using a first modem of the UE associated with the first RAT is configured to provide the data to a first TCP stack associated with the first RAT instead of a second TCP stack associated with the second RAT. In an aspect, the first RAT includes a cellular RAT associated with a first modem of the UE and the second RAT includes a WiFi RAT associated with a second modem of the UE. In an aspect, the apparatus 702/702′ may further include means for causing communication of the data over the second RAT based on the communication of the data over the first RAT. In an aspect, the means for causing communication of the data over the second RAT based on the communication of the data over the first RAT is configured to determine an issue associated with the communication of the data over the first RAT, wherein the communication over the second RAT is based on the issue. In an aspect, the apparatus 702/702′ may further include means for determining a type of data that is to be communicated, wherein the selection of the first RAT is based on the type of data to be communicated. In an aspect, the type of data is determined to be secure. In an aspect, the means for determining a rule associated with the type of data, wherein the selection of the first RAT is based on applying the determined rule to the type of data to be communicated. In an aspect, the selection of the first RAT is based on an application associated with the data. In an aspect, the apparatus 702/702′ may further include means for determining other data associated with another application. In an aspect, the apparatus 702/702′ may further include means for selecting the second RAT over which the other data is to be communicated based on the other application. In an aspect, the apparatus 702/702′ may further include means for causing communication of the other data over the second RAT using a second modem of the UE associated with the second RAT.

The aforementioned means may be one or more of the aforementioned components of the apparatus 702 and/or the processing system 814 of the apparatus 702′ configured to perform the functions recited by the aforementioned means. As described supra, the processing system 814 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), the method comprising:
determining data to be wirelessly communicated by the UE;
selecting, based on the data, a first radio access technology (RAT) over which the data is to be communicated instead of a second RAT; and
causing communication of the data over the first RAT using a first modem of the UE associated with the first RAT.

2. The method of claim 1, wherein causing communication of the data over the first RAT using a first modem of the UE associated with the first RAT comprises:
providing the data to a first transmission control protocol (TCP) stack associated with the first RAT instead of a second TCP stack associated with the second RAT.

3. The method of claim 1, wherein the first modem is a cellular modem and a second modem of the UE is a WiFi modem.

4. The method of claim 1, further comprising:
causing communication of the data over the second RAT based on the communication of the data over the first RAT.

5. The method of claim 4, wherein causing communication of the data over the second RAT based on the communication of the data over the first RAT comprises:
determining an issue associated with the communication of the data over the first RAT,
wherein the communication over the second RAT is based on the issue.

6. The method of claim 1, further comprising:
determining a type of data to be communicated,
wherein the selection of the first RAT is based on the type of data to be communicated.

7. The method of claim 6, wherein the type of data is determined to be secure.

8. The method of claim 6, further comprising:
determining a rule associated with the type of data,
wherein the selection of the first RAT is further based on applying the determined rule to the type of data to be communicated.

9. The method of claim 1, wherein the selection of the first RAT is based on an application associated with the data.

10. The method of claim 9, further comprising:
determining a second data associated with a second application;
selecting the second RAT over which the second data is to be communicated based on the second application; and
causing communication of the second data over the second RAT using a second modem of the UE associated with the second RAT.

11. An apparatus for wireless communication, comprising:
means for determining data to be wirelessly communicated by the apparatus;
means for selecting, based on the data, a first radio access technology (RAT) over which the data is to be communicated instead of a second RAT; and
means for causing communication of the data over the first RAT using a first modem of the apparatus associated with the first RAT.

12. The apparatus of claim 11, wherein the means for causing communication of the data over the first RAT using the first modem of the apparatus associated with the first RAT is configured to provide the data to a first transmission control protocol (TCP) stack associated with the first RAT instead of a second TCP stack associated with the second RAT.

13. The apparatus of claim 11, wherein the first modem is a cellular modem and a second modem of the apparatus is a WiFi modem.

14. The apparatus of claim 11, further comprising:
means for causing communication of the data over the second RAT based on the communication of the data over the first RAT.

15. The apparatus of claim 14, wherein the means for causing communication of the data over the second RAT based on the communication of the data over the first RAT is configured to:
determine an issue associated with the communication of the data over the first RAT,
wherein the communication over the second RAT is based on the issue.

16. The apparatus of claim 11, further comprising:
means for determining a type of data that is to be communicated,
wherein the selection of the first RAT is based on the type of data to be communicated.

17. The apparatus of claim 16, wherein the type of data is determined to be secure.

18. The apparatus of claim 16, further comprising:
means for determining a rule associated with the type of data,
wherein the selection of the first RAT is based on applying the determined rule to the type of data to be communicated.

19. The apparatus of claim 11, wherein the selection of the first RAT is based on an application associated with the data.

20. The apparatus of claim 19, further comprising:
means for determining other data associated with another application;
means for selecting the second RAT over which the other data is to be communicated based on the other application; and
means for causing communication of the other data over the second RAT using a second modem of the apparatus associated with the second RAT.

21. An apparatus for wireless communication, comprising:
a memory; and
at least one processor coupled to the memory and configured to:
determine data to be wirelessly communicated by the apparatus;
select, based on the data, a first radio access technology (RAT) over which the data is to be communicated instead of a second RAT; and
cause communication of the data over the first RAT using a first modem of the apparatus associated with the first RAT.

22. The apparatus of claim 21, wherein the at least one processor is further configured to provide the data to a first transmission control protocol (TCP) stack associated with the first RAT, instead of a second TCP stack associated with the second RAT, when the at least one processor is to cause communication of the data over the first RAT using the first modem.

23. The apparatus of claim 21, wherein the first modem is a cellular modem and a second modem of the apparatus is a WiFi modem.

24. The apparatus of claim 21, wherein the at least one processor is further configured to cause communication of the data over the second RAT based on the communication of the data over the first RAT.

25. The apparatus of claim 24, wherein the at least one processor is configured to cause communication of the data over the second RAT based on the communication of the data over the first RAT based on determination of an issue associated with the communication of the data over the first RAT,
wherein the communication over the second RAT is based on the issue.

26. The apparatus of claim 21, wherein the at least one processor is further configured to determine a type of data that is to be communicated,
wherein the selection of the first RAT is based on the type of data to be communicated.

27. The apparatus of claim 26, wherein the type of data is determined to be secure.

28. The apparatus of claim 26, wherein the at least one processor is further configured to determine a rule associated with the type of data,
wherein the selection of the first RAT is based on applying the determined rule to the type of data to be communicated.

29. The apparatus of claim 21, wherein the selection of the first RAT is based on an application associated with the data.

30. A non-transitory computer-readable medium storing computer executable code for wireless communication of a user equipment (UE), comprising code to:
determine data to be wirelessly communicated by the UE;
select, based on the data, a first radio access technology (RAT) over which the data is to be communicated instead of a second RAT; and
cause communication of the data over the first RAT using a first modem of the UE associated with the first RAT.
